(19) United States
(12) Patent Application Publication
(10) Pub. No.: US 2019/0074673 A1
(43) Pub. Date: Mar. 7, 2019

(54) CABLE HOLDER COMPRISING A BASE

(71) Applicant: Tormaxx GmbH, Moenchengladbach (DE)

(72) Inventor: Hubert KOCH, Moenchengladbach (DE)

(73) Assignee: Tormaxx GmbH, Moenchengladbach (DE)

(21) Appl. No.: 16/085,202

(22) PCT Filed: Mar. 13, 2017
(86) PCT No.: PCT/DE2017/000064

§ 371 Date: Sep. 25, 2018

(30) Foreign Application Priority Data
Mar. 17, 2016 (DE) 10 2016 003 203.0
Jul. 25, 2016 (DE) 10 2016 009 184.3
Sep. 2, 2016 (DE) 10 2016 010 636.0

(51) Int. Cl. H02G 3/04; F16L 3/13

(52) U.S. Cl. CPC H02G 3/0437; F16L 3/13

(57) ABSTRACT

A cable holder having a base body has a cable guiding channel which a deformable holder is arranged in order to hold cable whose cross-sectional area is smaller than the cross-sectional area of the cable guiding channel.

The invention relates to a cable holder with a base body, wherein the base body has a cable guiding channel

In many places adhesive today adhesive pads are used, which are constructed of soft plastic materials in such a manner that a hemisphere on the underside has an adhesive pad by means of which the holder can be stuck on. The upper side is separated, apart from a few millimetres and has a hole in the centre. The cable can be pressed through the separating section from above through the cut into the centre of the hemisphere, where the cable is located. The cable is thus fixed in the adhesive holder because the cable is thicker than the opening slot.

However, when the cable is thinner than the hole in the adhesive holder, the cable is not fixed in the longitudinal direction and thus falls downwards through the hole again and again, fixing is only possible with additional expenditure, possibly the cable is to be fixed by suitable stoppers in front and behind or in front and behind the adhesive holder.

It is therefore the object of the invention to provide a cable holder which is suitable for different cable thicknesses and is simple to produce.

A new solution according to the invention is described in claim 1. Advantageous embodiments are described in the subclaims.

In the deformable holder a plurality of cables can also be held in the cable guiding channel. Or the cable holder has a plurality of cable guiding channels in which one cable or a plurality of cables can be held. The cable holder can also be configured in a modular manner in order to be able to hold many cables with a plurality of cable holders. For this purpose the individual cable holders can have form-fitting or force-fitting connecting elements which enable cable holders to be connected to one another and thus for example for a cable holder strip with a plurality of cable holders.

In order to improve the prior art in the case of cable holders which can also be used as adhesive pads, a centring membrane was invented which in particular with corresponding incisions and a concave wall fixes the cables firmly in the longitudinal direction and thus prevents the lines from falling out or prevents the lines from slipping in the holder.

Independently of the other features of the invention, the optional feature is essential to the invention whereby the base body has a reinforcing plate which is arranged parallel to the axis of the guide channel. If the cable is very thick, the guide channel is bent up widely and this has the result that the base in the centre is pressed upwards on an axis parallel to the guide channel. This acts on the adhesive connection and can release the cable holder from the surface on which it is stuck.

This is prevented by using, for example, an inner core of ABS as a reinforcing plate, which can be recast at least on one side by a softer TPU material. The reinforcement thus acts as a leaf spring and is suitable for squeezing the slot of the cable channel in which the cables lie. At the same time, the reinforcement can form the base of the cable holder which no longer sags as a result of the strength of the ABS and thus enables a particularly efficient adhesion for the adhesive device.

Two exemplary embodiments of cable holders are shown in the figure.

The cable holder 1 substantially consists of the base body 2 which has a cable guiding channel 3, and the deformable holder 4.

The base body 2 is made of an elastically deformable plastic so that cables whose cross-section approximately corresponds to the cross-section of the cable guiding channel 3 or is larger than the cross-section of the cable guiding channel 3 are held by the elasticity of the base body 2. Independently of one another, deformable wings 5, 6, 7 and 8 of the holder 4 thereby rest on the inner wall 9 of the cable guiding channel 3 in order to securely hold the cable.

If the cable has a smaller cross-section than the cable guiding channel, the wings 5, 6, 7 and 8 rests on the cable and press against the cable with their elasticity. As a result, the cable is pressed towards the centre of the cable guiding channel and held there. In order to securely hold a cable ora plurality of cables in the cable guiding channel 3, the base body 2 is made of elastically deformable plastic and the deformable holder 4 also has elastically deformable wings 6, 7 and 8.

The base body 2 has two retaining arms 10 and 11 arranged around the cable guiding channel 3, which are interconnected via a base surface 12. This base surface 12 has a flat adhesive surface 13 by means of which the base body 1 can be adhered to a surface (not shown).

In order to minimize the material usage, the base body 2 has the shape of a spherical segment with flattened side surfaces 14 and 15. A cable guiding channel 3 with circular cross-sectional area is formed by the retaining arms 10 and 11.

The wings 5, 6, 7 and 8 are configured as membranes in order on the one hand not to restrict the cross-section of the cable guiding channel too much for thick cables and on the other hand to hold thin cables securely.

In order to hold the cables securely, the four wings 5, 6, 7, 8 of the holder 4 form a concave inner side and a convex outer side. As a result, the wings 5, 6, 7, 8 together form a hollow spherical segment which combines elasticity and stability with one another.

The flexibility of the holder 4 is achieved by providing incisions 16, 17, 18 and 18 between the wings 5, 6, 7 and 7. One of these incisions 19 extends from the edge of the cable guiding channel 3 to its centre 20 in order to facilitate the insertion of the cable in the holder 4. For this purpose lips 21, 22 arranged at an acute angle with respect to one another are additionally provided which form a conically tapering insertion gap in the direction of the cable guiding channel.

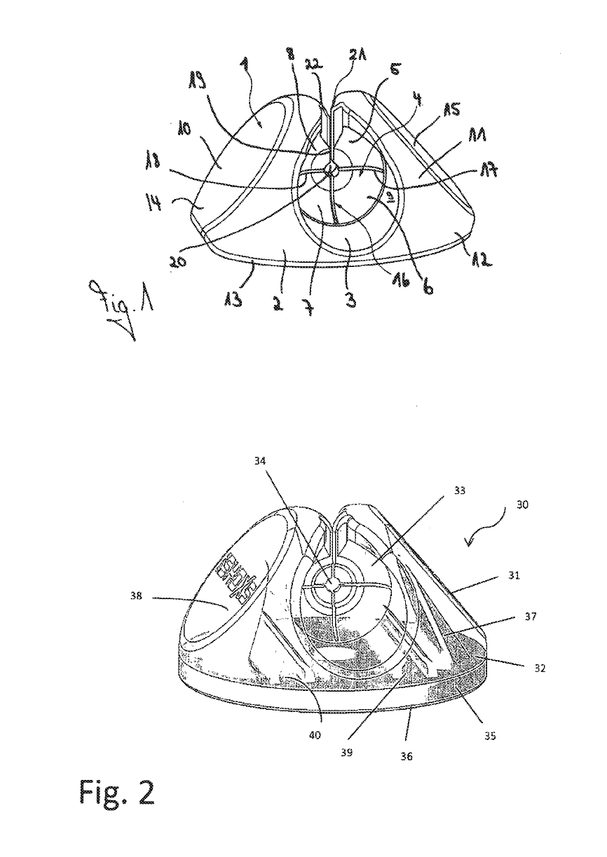

The holder 30 shown in FIG. 2 has a base body 31 with a core made of ABS which is arranged as a reinforcing plate 32 under the guide channel 33. The reinforcing plate 32 is arranged parallel to the axis 34 of the guide channel 33. This reinforcing plate 32 has a base 35 with an adhesive surface 36 and two swords 37 and 38 on two sides of the guide channel 33. Two slightly bend double webs 39 and 40 ensure a sable connection of the ABS material of the reinforcement with the TPU which as elastically deformable plastic 41 forms the guide channel 33. These double webs 39 and 40 also reinforce the base plate 35.

1-14. (canceled)

15. A cable holder having a one-part base body made of elastically deformable plastic which has the shape of a spherical segment and a cable guiding channel, wherein a deformable holder configured as a membrane is arranged in the cable guiding channel which can hold cable whose cross-sectional area is smaller than the cross-sectional area of the cable guiding channel, wherein the base body has a reinforcing plate which is arranged parallel to the axis of the guiding channel and the reinforcing plate has reinforcing swords embedded in deformable plastic laterally of the guide channel.

16. The cable holder according to claim 15, wherein the base body has a—preferably round and plane—adhesive surface.

17. The cable holder according to claim 15, wherein the cable guiding channel has a circular cross-sectional area.

18. The cable holder according to claim 15, wherein the holder has a concave inner side and a convex outer side as the surface.

19. The cable holder according to claim 15, wherein the holder has an incision which runs from the edge to the centre of the cable guiding channel.

20. The cable holder according to claim 19, wherein the incision has lips arranged at an acute angle with respect to one another.

21. The cable holder according to claim 19, wherein it has a plurality of incisions which run radially to the centre of the cable guiding channel.

22. The cable holder according to claim 15, wherein the reinforcing plate has reinforcing swords laterally of the guide channel.

23. The cable holder according to claim 15, wherein the reinforcing plate has reinforcing webs running parallel to the guide channel.

24. The cable holder according to claim 23, wherein the reinforcing webs are embedded in elastically deformable plastic.
